(19) United States
(12) Patent Application Publication
(10) Pub. No.: US 2012/0162985 A1
(43) Pub. Date: Jun. 28, 2012

(54) SOLID STATE LIGHTING UNIT INCORPORATING OPTICAL SPREADING ELEMENTS

(75) Inventors: Rick Kauffman, Buford, GA (US); Donald Sipes, Colorado Springs, CO (US)

(73) Assignee: SUNOVIA ENERGY TECHNOLOGIES, INC., Sarasota, FL (US)

(21) Appl. No.: 13/266,108

(22) PCT Filed: Apr. 26, 2010
(86) PCT No.: PCT/US10/32443

§ 371 Date: Mar. 15, 2012

Related U.S. Application Data
(60) Provisional application No. 61/172,635, filed on Apr. 24, 2009.

(51) Int. Cl. F21V 5/04; F21V 29/00

(52) U.S. Cl. 362/244; 362/235; 362/332

(57) ABSTRACT

A desired output from a solid state lighting assembly is generated using a combination of a light assembly and an external protective lens. Provided are aspects in which the spreading and/or steering of aimed beams from individual light elements is achieved by through sections formed into an external protective lens. This may be embodied either in a luminaire originally designed to utilize solid state lighting elements, such as LEDs, or in a retrofit device or mechanism designed to convert an existing luminaire that uses a traditional light source into a luminaire that uses solid state lighting elements.

### CROSS-REFERENCE TO RELATED APPLICATIONS

This application claims priority to U.S. Provisional Patent Application No. 61/172,635, filed on Apr. 24, 2009, the entire disclosure of which is incorporated herein by reference.

### FIELD

The present disclosure relates to solid state lighting, and optical spreading elements used in solid state lighting to achieve desired illumination patterns.

### BACKGROUND

Lighting systems traditionally use various different types of illumination devices, commonly including incandescent lights, fluorescent lights, and Light Emitting Diode (LED) based lights. LED based lights generally rely on multiple diode elements to produce sufficient light for the needs for a particular application of the particular light or lighting system. As an approach to offset the ever increasing price of energy and make a meaningful indent to the production of greenhouse gases, LED lighting offers great promise in this regard. With efficacies approaching 150 lumens per Watt, and lifetimes at over 50,000 Hours, LEDs and lighting products based on LED technology may potentially make significant inroads in the lighting market in residential and commercial, indoor and outdoor applications.

LED based lights offer significant advantages in efficiency and longevity compared to, for example, incandescent sources, and produce less waste heat. For example, if an ideal solid-state lighting device were to be fabricated, the same level of luminance can be achieved by using merely 1/20 of the energy that an equivalent incandescent lighting source requires. LEDs offer greater life than many other lighting sources, such as incandescent lights and compact fluorescents, and contain no environmentally harmful mercury that is present in fluorescent type lights. LED based lights also offer the advantage of instant-on and are not degraded by repeated on-off cycling.

As mentioned above, LED based lights generally rely on multiple LED elements to generate light. An LED element, as is well known in the art, is a small area light source, often with associated optics that shape the radiation pattern and assist in reflection of the output of the LED. LEDs are often used as small indicator lights on electronic devices and increasingly in higher power applications such as flashlights and area lighting. The color of the emitted light depends on the composition and condition of the semiconducting material used to form the junction of the LED, and can be infrared, visible, or ultraviolet.

Within the visible spectrum, LEDs can be fabricated to produce desired colors. For applications where the LED is to be used in area lighting, a white light output is typically desirable. There are two common ways of producing high intensity white-light LED. One is to first produce individual LEDs that emit three primary colors (red, green, and blue), and then mix all the colors to produce white light. Such products are commonly referred to as multi-colored white LEDs, and sometimes referred to as RGB LEDs. Such multi-colored LEDs generally require sophisticated electro-optical design to control the blend and diffusion of different colors, and this approach has rarely been used to mass produce white LEDs in the industry to date. In principle, this mechanism has a relatively high quantum efficiency in producing white light.

A second method of producing white LED output is to fabricate a LED of one color, such as a blue LED made of InGaN, and coating the LED with a phosphor coating of a different color to produce white light. One common method to produce such and LED-based lighting element is to encapsulate InGaN blue LEDs inside of a phosphor coated epoxy. A common yellow phosphor material is cerium-doped yttrium aluminum garnet (Ce3+:YAG). Depending on the color of the original LED, phosphors of different colors can also be employed. LEDs fabricated using such techniques are generally referred to as phosphor based white LEDs. Although less costly to manufacture than multi-colored LEDs, phosphor based LEDs have a lower quantum efficiency relative to multi-colored LEDs. Phosphor based LEDs also have phosphor-related degradation issues, in which the output of the LED will degrade over time. Although the phosphor based white LEDs are relatively easier to manufacture, such LEDs are affected by Stokes energy loss, a loss that occurs when shorter wavelength photons (e.g., blue photons) are converted to longer wavelength photons (e.g. white photons). As such, it is often desirable to reduce the amount of phosphor used in such applications, to thereby reduce this energy loss. As a result, LED-based white lights that employ LED elements with such reduced phosphor commonly have a blue color when viewed by an observer.

Various other types of solid state lighting elements may also be used in various lighting applications. Quantum Dots, for example, are semiconductor nanocrystals that possess unique optical properties. The emission color of quantum dots can be tuned from the visible throughout the infrared spectrum. This allows quantum dot LEDs to create almost any output color. Organic light-emitting diodes (OLEDs) include an emitting layer material that is an organic compound. To function as a semiconductor, the organic emitting material must have conjugated pi bonds. The emitting material can be a small organic molecule in a crystalline phase, or a polymer. Polymer materials can be flexible; such LEDs are known as PLEDs or FLEDs.

In an ideal situation, luminaires may be designed to optimally incorporate LEDs and make full use of the various properties and advantages for the particular LED that is incorporated into the luminaire. However, in many cases it may be desirable to retrofit an existing light housing to incorporate a solid state light unit. For example, it may desired to preserve the housing of a luminaire for re-use so as to avoid the cost of completely replacing the entire light housing, which can have considerable cost.

### SUMMARY

The present disclosure provides methods and apparatuses for generating a desired output from a solid state lighting assembly. Provided are aspects in which the spreading and/or steering of aimed beams from individual light elements is achieved by through sections formed into an external protective lens. This may be embodied either in a luminaire originally designed to utilize solid state lighting elements, such as LEDs, or in a retrofit device or mechanism designed to convert an existing luminaire that uses a traditional light source into a luminaire that uses solid state lighting elements.

In one aspect, the present disclosure provides a solid state lighting assembly, comprising (a) an optical assembly that comprises a plurality of discrete mounting surfaces; (b) a plurality of solid state light elements mounted to respective mounting surfaces; and (c) a lens comprising a plurality of discrete facets, each of which correspond to a respective discrete mounting surface, at least some of said plurality of discrete facets comprising an optical lens. The optical assembly may further comprise a heat sink, and the solid state light elements may comprise light emitting diode (LED) light elements. In some embodiments, at least some of the solid state light elements comprise an LED module and a secondary optic optical lens. Such a secondary optic optical lens may comprise at least one of a collimating lens, a spreading lens, and a steering lens. In another embodiment, some, if not all, of the plurality of discrete facets corresponds to an associated discrete mounting surface, and the discrete facets are generally planer and substantially parallel to a plane of an associated mounting surface. In another embodiment, each of the plurality of solid state light elements provides light output along a primary axis, and each of said discrete facets has an associated adjacent light element, and wherein a plane of each of said discrete facets is substantially perpendicular to the primary axis of the adjacent light element.

In another aspect, the present disclosure provides an external lens adapted to be mounted to a solid state lighting assembly having a plurality of point light sources mounted to a plurality of discrete mounting surfaces having different physical orientations, the external lens comprising a plurality of facets that each correspond to one or more of the mounting surfaces, one or more of said plurality of facets comprising an optical spreading lens. The optical spreading lens may comprise a frensel type lens. Each of the plurality of discrete facets, in an embodiment, corresponds to an associated discrete mounting surface. In another embodiment, at least one of the plurality of discrete facets is generally planer and substantially parallel to a plane of an associated discrete mounting surface.

In still another aspect, the present disclosure provides a method for providing desired illumination to an area to be illuminated, comprising: (a) determining a desired illumination pattern to the area to be illuminated; (b) selecting a first light assembly having a first light output pattern generated from a plurality of point light sources that are mounted to a plurality of different mounting surfaces; (c) providing two or more external lenses, each external lens comprising a plurality of facets that each correspond to one or more of the mounting surfaces, one or more of said plurality of facets comprising an optical spreading lens that is different for each provided external lens; and (d) selecting one of the two or more external lenses that, when coupled to said first light assembly, provides the desired illumination pattern. In an embodiment, the method further comprises mounting the selected external lens to said first light assembly to provide at least a portion of said desired illumination pattern. In another embodiment, the method further comprises determining a mounting height of the first light assembly above the area to be illuminated, and determining a distance between adjacent light assemblies in the area to be illuminated, and the selecting one of the two or more external lenses is based on one or more of the mounting height and distance between adjacent light assemblies. In a further embodiment, the first light assembly is selected from two or more types of light assemblies, each type of light assembly having a different light output pattern generated from a plurality of point light sources that are mounted to a plurality of different mounting surfaces, and the selecting a first light assembly and the selecting one of the two or more external lenses may be based on a resultant output pattern of the combined light assembly and external lens. At least one of the types of light assemblies may provide an output that is greater than other types of light assemblies.

### BRIEF DESCRIPTION OF THE DRAWINGS

FIG. 1 is a bottom perspective view of a solid state lighting assembly of an aspect of the disclosure;

FIG. 2 is a bottom perspective view of a lens incorporating optical elements for use with a solid state lighting assembly of an aspect of the disclosure;

FIG. 3 is a side elevation view of a solid state lighting assembly of an aspect of the disclosure;

FIG. 4 is a cross-sectional illustration of the solid state lighting assembly of FIG. 3; and

FIG. 5 is an illustration of a secondary optic of various embodiments.

### DETAILED DESCRIPTION

The present disclosure recognizes that it is desirable in LED-based lighting design to create a low-cost LED lamp containing an array of LEDs. The present disclosure also recognizes that it is desirable to create a uniform illumination pattern or, in cases, where a specific non-uniform illumination pattern is desired, it is desirable to provide illumination in the desired pattern. Furthermore, the present disclosure recognizes that in many cases it is desirable to provide a retrofit device or mechanism designed to both fit into an existing luminaire housing designed for a non-solid-state light, while also making use of solid state light elements such as LEDs. The present disclosure provides light units that meet these criteria, as well as methodology to produce such an enhanced design. The application in which the lamp is to be used, such as roadway illumination, has a basic output pattern requirement. Such an output pattern requirement may include minimum illumination in foot candles, and an area range of illumination depending on the height of the lamp and the spacing between the lamps. Initially, one or more light units are provided that each have a known illumination pattern based on the height of the lamp, spacing between lamps, and optical characteristics of the light elements when all or some are illuminated. Exterior lenses are available that have optical components located therein that are complementary to the light elements within the lamp. Based on the illumination pattern of the lamps and the desired illumination pattern, exterior lenses may be selected to provide a light output that corresponds to the desired illumination pattern. Thus, the present disclosure provides a lamp with a desired output pattern while reducing lamp cost through reduced numbers of light elements and reduced optics required for a lamp. Furthermore, manufacturing efficiencies may be improved by producing lamp assemblies and exterior lens assemblies that, when combined, produce a variety of illumination patterns, one or more of which may be selected to provide desired illumination patterns in a particular application. Throughout this disclosure reference will be made to LEDs with the understanding that concepts described herein may be applied to other types of solid state light elements, such as those described above.

When attempting to retrofit an existing device, several properties related to LEDs present challenges to implementing a suitable design that accomplishes an equivalent, or better, lighting output for the housing with the originally designed light source. For example, the output from LEDs is much more directional than the output of an incandescent light. Considerations related to providing adequate light from the luminaire over the entire area that is to be lighted also must be included in any design. In this regard, LED output can be most efficiently utilized when the optical system of the luminaire is designed to place the correct amount of light precisely where it is required. This may require controlled collimation of the LEDs' output, correct aiming of that collimated beam of light, and in many applications, some of those beams need to be spread over a greater of lesser areas than other beams. Present implementations may spread those LED beams using a spreading lens attached to a collimating lens or incorporated into the collimating lens.

Typical devices that provide protection for a light source or sources from the outside environment include lenses or other covering that light from the light source is transmitted through. These lenses or coverings are commonly composed of glass, a polymer, or blend of polymers. These protective lenses or coverings may also be constructed to act as refractive elements in luminaires with traditional light sources. These lenses may be flat-surfaced or rounded.

In am exemplary embodiment, a LED luminaire or luminaire retrofit device provides light produced by the LEDs that is directed to desired locations where light is needed by aiming the LEDs and any secondary collimating optics, and focusing the output of each light source as needed via spreading lenses to achieve the desired pattern of foot-candles on the ground. Individual spreading lenses may be attached to the collimating lens or incorporated into the top surface of the collimating lens. The LEDs and their secondary optics are then protected from the outside elements by means of an external lens that is faceted with each facet oriented orthogonally to the aiming axis or vector of each LED.

Such a spreading lens arrangement provides a desired pattern of light, where individual spreading lenses are properly selected and attached to each collimating lens, or each collimating lens incorporates a different degree of beam spread and is selected to create the required light pattern. This method provides an accurate, optically effective light pattern, and provides a great deal of flexibility to address the potential need for producing various patterns.

In another exemplary embodiment, a solid state light unit is provided that incorporates optical spreading elements into an external protective lens. Different facets of the external protective lens, in an embodiment, contain an optical element that acts as an optical beam spreader or a steering element as needed by the desired pattern of light on the ground. Such an external lens enables manufacturing efficiencies to be greatly increased by having only one external lens to change if a variation in pattern is needed. In this embodiment, the cost of manufacturing and placing individual spreading and/or steering lenses is reduced. Optical spreading or steering elements incorporated into the external protective lens may include, for example, frensel type lenses that shape the light output from individual LED and associated secondary optics to create wider and oval type patterns. The optical spreading or steering elements incorporated into the external protective lens may include any suitable optical element, such as prisms and lenses, for example.

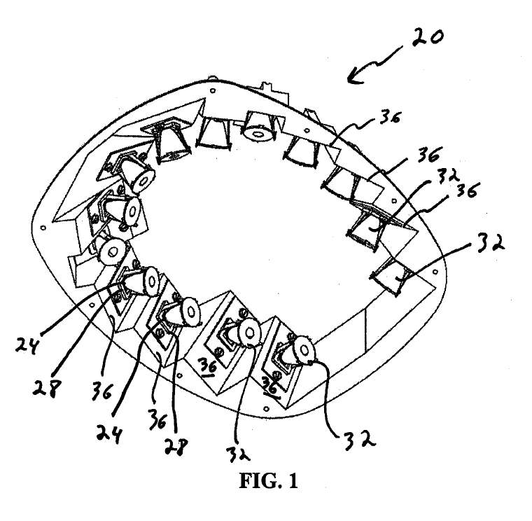

In an embodiment, illustrated in FIG. 1, optical spreading and/or steering elements are incorporated into an external protective lens. Such elements may be formed as part of the lens through, for example, molding, casting, laser cutting or ablation, machining, mechanical forming, or vacuum forming. With reference to FIG. 1, an exemplary embodiment is provided in which a retrofit assembly 20 is sized and shaped to fit into an existing light housing. The assembly 20 includes LED modules 24 that are mounted to a circuit board 28. The circuit board 28 is connected to a power supply (not shown in FIG. 1) and, in some embodiments, include a heat dissipating structure. Mounted to the circuit boards 28 for each LED module 24 are secondary optics 32 which may include collimating lenses, spreading lenses, and/or steering lenses. The assembly 20 is configured with a plurality of mounting surfaces 36 such that the associated LED module 24 and secondary optics 32 is aimed in a desired direction. When all, or some, of the LED modules 24 are illuminated the resultant output forms the desired illumination pattern is formed based on the different directions in which each respective illuminated LED module 24 and associated secondary optics 32. As mentioned, the various mounting surfaces 36 may be designed based on specific criteria for a particular light unit 20. Such criteria may include the intensity of the light that is to be incident upon a lighted surface, the distance between the light unit and the lighted surface, and criteria related to glare or valence that may be present for a particular application, to name a few. As also mentioned above, designing a retrofit assembly 20 according to specific needs of each particular application can generate additional costs and be relatively inefficient where a retrofit assembly 20 may be incorporated into numerous light housings in numerous different applications. For example, the light housing to be retrofitted may be a street light, with a particular municipality having numerous such lights where a first output pattern is desired, and numerous other municipalities having the same or similar lights where other output patterns are desired.

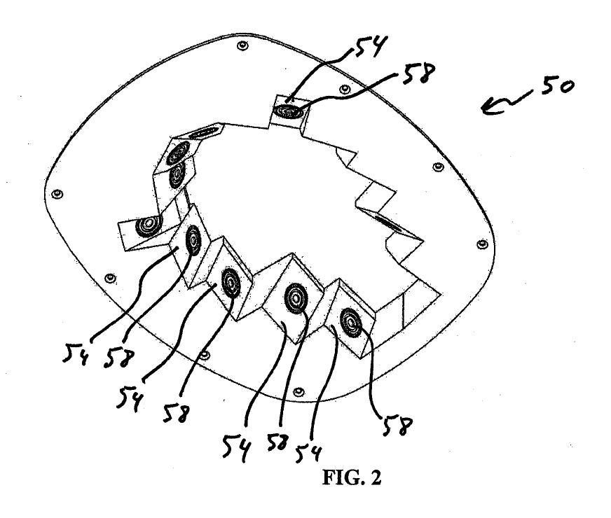

In an exemplary embodiment, an external lens 50, illustrated in FIG. 2, is provided that cooperates with the retrofit assembly 20 of FIG. 1. The external lens 40, in the embodiment illustrated in FIG. 2, is a single piece lens with multiple facets 54. Each facet, in this embodiment, is oriented so as to be orthogonal to the primary aiming axis or vector of each LED module 24 and its associated secondary optic 32. Incorporated into some, or all, of the facets 54 is an optical element 58 that may be a spreading lens or some other form of optical steering. In this embodiment, the secondary optics 32 of the retrofit assembly 20 include collimating lenses, with any spreading and/or steering optics being incorporated into lens 40. In such a manner, a device or mechanism utilizing a multiplicity of LED packages may be adjusted to provide a desired output pattern by providing a different protective lens while using the same base assembly 20. Similarly, a multiplicity of small arrays of LEDs with all the LEDs in a given small array being aimed in the same direction may be coupled with different protective lenses to provide desired output patterns. For example, each mounting surface 36 may include an array of five LED modules 24 and associated secondary optics 32, that are mounted on a single (or multiple) circuit board 28.

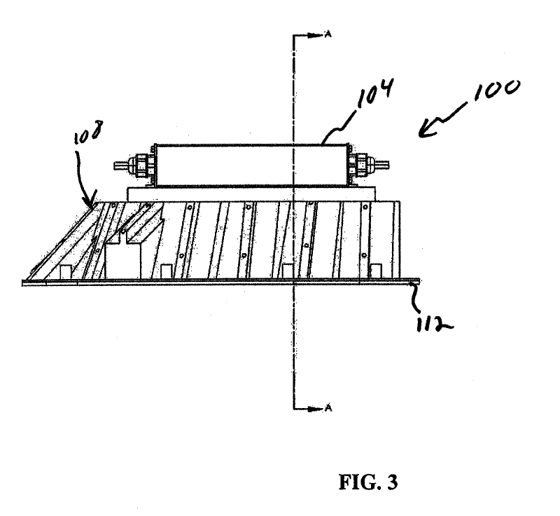

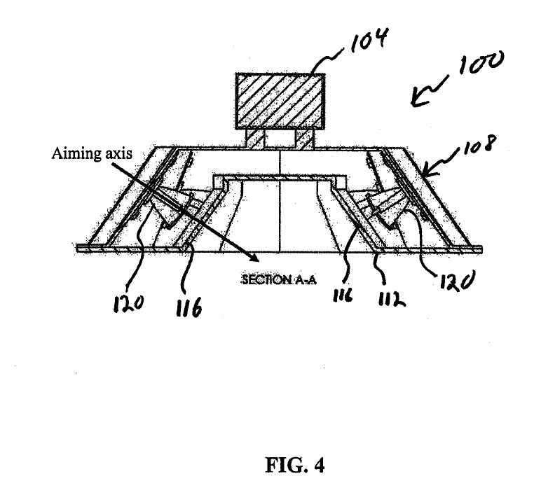

With reference now to FIG. 3, a side plan view of a lamp assembly 100 of an embodiment is illustrated. In this embodiment, the lamp assembly 100 includes a power supply 104, a housing and aiming platform 108, and external protective lens 112. The power supply 104 receives incoming AC power and converts this power in to DC power that is used to power the solid state lighting elements that are included in the housing and aiming platform 108. FIG. 4 is a cross-sectional illustration, along section A-A of FIG. 3. As can be seen from the illustration, the protective lens 112 in this embodiment includes facets 116 that are orthogonal to the aiming axis of individual lighting elements 120, which in this embodiment include an LED assembly and secondary optic. Similarly as described above, the facets 116 may include a spreading and/or steering lens such that the ensemble of the individual lighting elements 120 provides a desired illumination output over a lighted area.

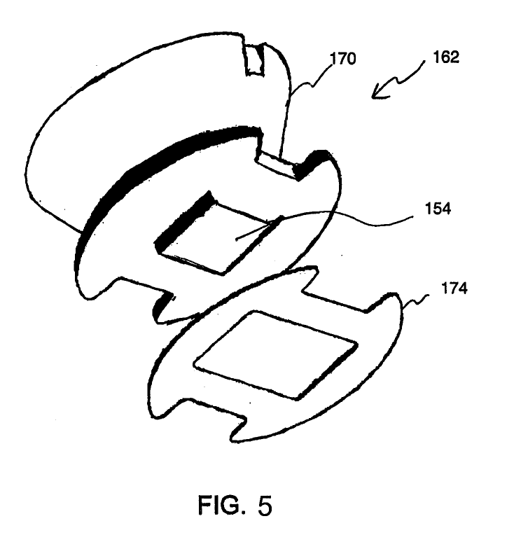

FIG. 5 illustrates a collimating optic component 162 that is used as a secondary optic in one embodiment. The collimating optic 162 includes lens portion 170 that is adapted to receive an LED light element through aperture 154. The lens 170 is mounted to a substrate using an adhesive pad 174, in this embodiment. In some embodiments, frensel type lenses may be attached to the lens 170 to further shape the light output. As mentioned above, the secondary optic component, in combination with optical spreading and/or steering elements incorporated into an external protective lens, can be used to achieve a desired output by using an appropriate combination of uncollimated, narrowly collimated, wide angle and/or oval projection LED beam patterns. As will be readily understood by one of skill in the art, other types of secondary optics may be used depending upon the desired output beam of a particular light element.

Other embodiments provide multiple lenses that may be coupled with a lamp assembly to provide for the changing of the light pattern of a luminaire from one type pattern to another, i.e. Type II to Type III simply by clinging the external protective lens that incorporates the spreading and/or steering elements. This thus provides a swift and simple change compared to changing multiple spreading and/or steering elements in the lamp assembly itself, and therefore more cost effective in cases where such flexibility is desired. In further embodiments, different types of light assemblies are provided that have different output patterns or output light levels (foot candles on illumination on the ground). The different light assemblies, couples with the different external lenses, may provide a number of different types of illumination patterns, with the appropriate combination selected based on the desired illumination pattern. In still further embodiments, the light assemblies are adjustable to provide different levels of light output through, for example, adjusting the power supply.

In other embodiments, spreading and/or steering elements are incorporated into an external lens (or lenses) that is faceted so as to make any or all of those facets orthogonal to the aiming axis or vector of the LED or LEDs and their associated optics. In other embodiments, a lens, or lenses, may be provided in which there are variations on the size, number, and orientation of the facets.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A solid state lighting assembly, comprising:
a optical assembly that comprises a plurality of discrete mounting surfaces;
a plurality of solid state light elements mounted to respective mounting surfaces; and
a lens comprising a plurality of discrete facets, each of which correspond to a respective discrete mounting surface, at least some of said plurality of discrete facets comprising an optical lens.

2. The solid state lighting assembly, as claimed in claim 1, wherein said optical assembly further comprises a heat sink.

3. The solid state lighting assembly, as claimed in claim 1, wherein said plurality of solid state light elements comprise light emitting diode (LED) light elements.

4. The solid state lighting assembly, as claimed in claim 1, wherein said plurality of solid state light elements each comprise an LED module that comprises a plurality of LEDs.

5. The solid state lighting assembly, as claimed in claim 1, wherein at least some of said plurality of solid state light elements comprise an LED module and a secondary optic optical lens.

6. The solid state lighting assembly, as claimed in claim 5, wherein said secondary optic optical lens comprises at least one of a collimating lens, a spreading lens, and a steering lens.

7. The solid state lighting assembly, as claimed in claim 1, wherein each of said plurality of discrete facets corresponds to an associated discrete mounting surface.

8. The solid state lighting assembly, as claimed in claim 1, wherein a subset of said plurality of discrete facets are generally planer and substantially parallel to a plane of an associated mounting surface.

9. The solid state lighting assembly, as claimed in claim 1, wherein each of said plurality of solid state light elements provides light output along a respective primary axis, and each of said discrete facets has an associated adjacent light element, and wherein a plane of each of said discrete facets is substantially perpendicular to the primary axis of the adjacent light element.

10. An external lens adapted to be mounted to a solid state lighting assembly having a plurality of point light sources mounted to a plurality of discrete mounting surfaces having different physical orientations, the external lens comprising:
a plurality of facets that each correspond to one or more of the mounting surfaces, one or more of said plurality of facets comprising an optical spreading lens.

11. The external lens, as claimed in claim 10, wherein said optical spreading lens comprises a frensel type lens.

12. The external lens, as claimed in claim 10, wherein each of said plurality of discrete facets corresponds to an associated discrete mounting surface.

13. The external lens, as claimed in claim 10, wherein at least one of said plurality of discrete facets are generally planer and substantially parallel to a plane of an associated discrete mounting surface.

14. A method for providing desired illumination to an area to be illuminated, comprising:
determining a desired illumination pattern to the area to be illuminated;
selecting a first light assembly having a first light output pattern generated from a plurality of point light sources that are mounted to a plurality of different mounting surfaces;
providing two or more external lenses, each external lens comprising a plurality of facets that each correspond to one or more of the mounting surfaces, one or more of said plurality of facets comprising an optical spreading lens that is different for each provided external lens;
selecting one of the two or more external lenses that, when coupled to said first light assembly, provides the desired illumination pattern.

15. The method of claim 14, further comprising:
mounting said selected external lens to said first light assembly to provide at least a portion of said desired illumination pattern.

16. The method of claim 14, further comprising determining a mounting height of said first light assembly above the area to be illuminated, and determining a distance between adjacent light assemblies in the area to be illuminated.

17. The method of claim 16, wherein said selecting one of the two or more external lenses is based on one or more of the mounting height and distance between adjacent light assemblies.

18. The method of claim 14, wherein said first light assembly is selected from two or more types of light assemblies, each type of light assembly having a different light output pattern generated from a plurality of point light sources that are mounted to a plurality of different mounting surfaces.

19. The method of claim 18, wherein said selecting a first light assembly and said selecting one of the two or more external lenses is based on a resultant output pattern of the combined light assembly and external lens.

20. The method of claim 18, wherein at least one of the types of light assemblies provides an output that is greater than other types of light assemblies.
